(19) United States
(12) Patent Application Publication
(10) Pub. No.: US 2007/0017306 A1
(43) Pub. Date: Jan. 25, 2007

(54) Sample tube

(76) Inventor: Peter William Woods, Cambridgeshire (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/493,029

(22) Filed: Jul. 26, 2006

(30) Foreign Application Priority Data
Jul. 24, 2005 (EP) 05106904.5

(51) Int. Cl. G01N 1/08; G01N 1/28

(52) U.S. Cl. 73/864.91

(57) ABSTRACT

A sample tube 1 has an upper body part 3 open at its upper end and a lower body part 4 extending downwardly therefrom and which engages, in use, in a supporting rack (not shown). The lower body part 4 is substantially solid or, if hollow, is at least closed from the upper body part 3, and the upper body part is internally segmented to provide a plurality of individual storage chambers 2 within the sample tube 1.

### BACKGROUND

The present invention relates to sample tubes and, more particularly, to sample tubes for use in sample management and screening systems, for example such as used in drug discovery processes.

Conventionally, in drug discovery processes and the like, multi-well micro-titre plates (or often simply “microplates”) have been used for sample storage. Such plates contain a large number of wells, for example, 96 or 384 individual wells. The SBS format standard plates are well known in the industry. However, with the growing need to avoid sample wastage SBS format plates with as many as 1536 wells have been introduced.

U.S. Pat. No. 5,916,526 discloses a multi-well container in which individual tubes are subdivided by partitions or septa which extend the height of the tube serving to compartmentalise the tubes.

It is desirable, however, to ensure, especially when working with very small samples of fluid, that the conventional pipetting syringe can withdraw substantially all the fluid from a compartment or chamber and it is desirable therefore to ensure that the pipetting syringe tip can reach the bottom of the compartments.

In 2003, The Automation Partnership introduced its PicoTube™, for storage at a very high density in 384-SBS format racks, allowing processing just like 384 well micro-titre plates. Such PicoTubes™ have a total volume of about 100 μl and using appropriate picking robots, systems can maintain high storage densities and throughput rate.

### SUMMARY OF THE INVENTION

According to the present invention, a sample tube comprising an upper body part open at its upper end and a lower body part extending downwardly therefrom for engagement, in use, in a supporting rack, the lower body part being of smaller cross-sectional area than the upper body part and being substantially solid or closed from the upper body part, and the upper body part being internally segmented to provide a plurality of individual storage chambers within the sample tube.

By virtue of the fact that the chambers do not extend the height of the sample tube, but substantially only through the wider upper body part, the cross-sectional dimension of the chambers can be arranged to be sufficiently wide to enable a pipetting syringe tip to reach the bottom of each chamber and to prevent jamming of the tip in the chamber above the bottom. It is an advantage, further, if the lower end of each chamber is curved concavely. The cross-section of the chambers may be substantially constant over their length.

The upper body part may have a substantially square cross-section and the lower body part is preferably stepped inwardly from the upper body part.

Preferably, the main or upper body part is divided into four chambers by a pair of intersecting cross-walls formed between opposite sides of the sample tube.

The individual chambers may extend partly into the lower body part.

Preferably, the lower body part is solid, but it may be hollow, in which case the lower body part and main upper body part are separated by a transverse wall.

Such a sample tube provides advantages of flexibility in use whilst enabling very small volumes to be operated on or stored, for example, providing the equivalent of 1536 storage wells within a standard 384-SBS format rack. Each sample tube may be sealed by a conventional membrane seal and individual chambers may be accessed by automated sampling equipment either by piercing the seal or first removing it. Alternatively a septum type seal may be used which provides a re-sealing capability. A particular advantage in drug discovery processes for example is the ability to provide multiple volumes of the same compound in a single PicoTube™ enabling processing of one of the volumes and the ability to return to an identical sample in the event of successful results on the first sample.

### BRIEF DESCRIPTION OF THE DRAWINGS

Two examples of sample tubes according to the present invention will now be described with reference to the accompanying drawings in which:

FIG. 1 is an isometric view of the sample tube;

FIG. 2 is an isometric sectional view through the sample tube of FIG. 1;

FIG. 3 is a longitudinal section through the sample tube of FIG. 1;

FIG. 4 is a top plan view of the sample tube; and

FIG. 5 is a longitudinal section through a second sample tube.

### DETAILED DESCRIPTION

The sample tube 1 shown in the figures is the size of a conventional PicoTube™ designed by The Automation Partnership and manufactured and marketed by Matrix Technologies Corporation formed from polypropylene for use in a 384-way SBS format rack, but includes four separate chambers 2 according to the invention.

The PicoTube™ 1 has a generally square cross-section and is stepped in external profile providing, effectively, an upper or main body part 3 and a lower body part 4 which is of slightly smaller cross-section area and tapers very slightly towards its lower end. Other sample tubes may have a circular cross-section. The externally stepped shape of the PicoTube™ 1, together with a detent bump 5 provided at the lower end of the lower body part 4 allows the PicoTube™ to be held securely in a rack (not shown), in use with the ledge or step 6 between the outer surfaces of the lower and upper body parts providing a stop which rests against the upper surface of the rack in use.

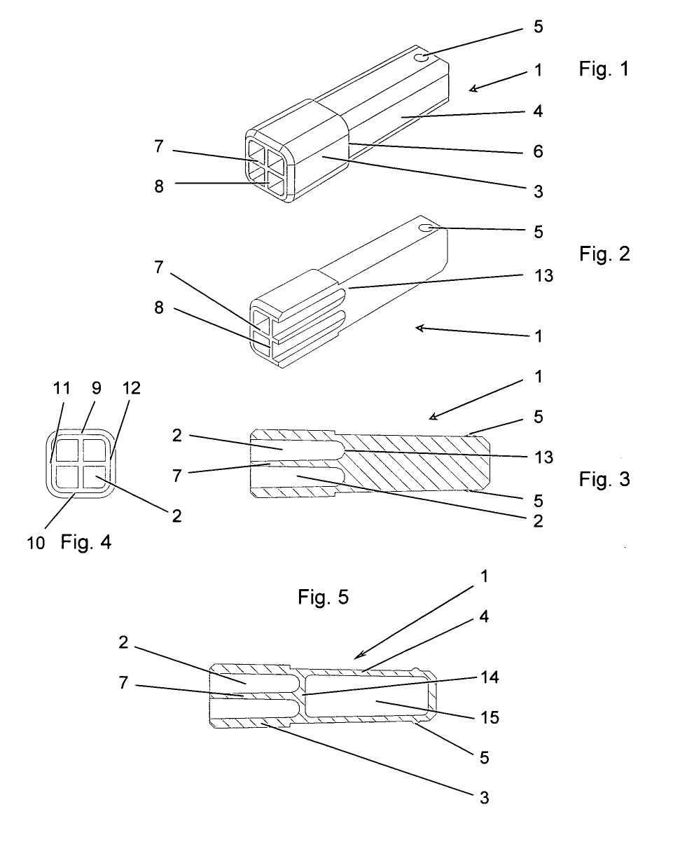

Unlike a conventional PicoTube™, the sample tube 1 shown in FIGS. 1 to 4 of the drawings has a substantially solid lower body part 4 as indicated by the cross-hatching in FIG. 3. The upper or main body part 3 is divided into the four chambers 2 by means of a pair of cross walls 7,8 extending, orthogonally with respect to one another, across between opposed side walls 9,10 and 11,12 respectively so that the chambers 2 are generally square in cross-section and provide chambers of equal volumes. Each of the chambers 2 has a substantially constant cross-sectional dimension over its length which prevents the tip of a pipetting syringe from jamming in the chamber and therefore allows the syringe tip to reach the bottom of each chamber which enables the substantially all of a fluid sample disposed in the chamber to be withdrawn through the tip of a pipetting syringe in use. A concavely curved lower end 13 in each chamber further facilitates this. The individual storage chambers extend partly below the level of the step 6.

In use, after a sample compound has been delivered into the chambers 2, the top of the PicoTube™ can be sealed by the conventional foil membrane seal (not shown).

As is also conventional on PicoTube™ the lower end of the sample tube is provided with a black surface on which a dot code can be provided for identification of individual tubes.

In a further example shown in FIG. 5, the lower body part is not solid, but is hollow and is separated from the upper body part by a transverse wall 14 which closes the bottom of the upper body part and the top of the lower body part. The tube may be formed using a mould with a side-positioned core piece to facilitate formation of the hollow volume 15. In other respects it is substantially the same as the sample tube of FIGS. 1 to 4.

In both examples the form of the sample tube is such as to resist flexing.

1. A sample tube comprising an upper body part open at its upper end and a lower body part extending downwardly therefrom for engagement, in use, in a supporting rack, the lower body part being of smaller cross-sectional area than the upper body part and being substantially solid or closed from the upper body part, and the upper body part being internally segmented to provide a plurality of individual storage chambers within the sample tube.

2. A sample tube according to claim 1, the upper body part having a substantially square cross-section.

3. A sample tube according to claim 1 or claim 2, wherein the lower body part is stepped inwardly from the upper body part.

4. A sample tube according to claim 1, wherein the upper body part is divided into four chambers by a pair of intersecting cross-walls formed between opposite sides of the sample tube.

5. A sample tube according to claim 1, wherein the individual storage chambers extend partly into the lower body part.

6. A sample tube according to claim 1, wherein the lower body part is solid.

7. A sample tube according to claims 1, wherein the lower body part is hollow and is separated from the upper body part by a transverse wall.

8. A sample tube according to claim 1, wherein the lower end of each chamber is curved concavely.
